(19) United States
(12) Patent Application Publication
(10) Pub. No.: US 2025/0051933 A1
(43) Pub. Date: Feb. 13, 2025

(54) METHOD FOR OPERATING AN ELECTROLYSIS SYSTEM, RECOMBINER, AND USE OF A RECOMBINER IN AN ELECTROLYSIS SYSTEM

(71) Applicant: Siemens Energy Global GmbH & Co. KG, München (DE)

(72) Inventors: Marc Hanebuth, Nürnberg (DE); Alexander Tremel, Möhrendorf (DE); Erik Wolf, Röttenbach (DE)

(21) Appl. No.: 18/687,343

(22) PCT Filed: Aug. 5, 2022
(86) PCT No.: PCT/EP2022/072083

§ 371 Date: Feb. 28, 2024

(30) Foreign Application Priority Data
Sep. 27, 2021 (EP) 21199190.6

(51) Int. Cl. C25B 1/04; C25B 9/70; C25B 11/061; C25B 11/067; C25B 15/027; C25B 15/08

(52) U.S. Cl. CPC C25B 1/04; C25B 9/70; C25B 11/061; C25B 11/067; C25B 15/027; C25B 15/083

(57) ABSTRACT

Methods for operating an electrolysis system that includes an electrolyzer for generating hydrogen and oxygen as product gases, a product gas flow being formed in a phase mixture including water and a respective product gas with a content of a foreign gas are provided. A rotation is impressed upon at least one product gas flow such that a phase separation of water and product gas is produced in the phase mixture, wherein the product gas is supplied to a catalytically active zone such that foreign gas is recombined with the product gas in order to form water, and after flowing through the catalytically active zone, the product gas released from the foreign gas is mixed with the liquid phase again in order to form a phase mixture.

### BACKGROUND

A method for operating an electrolysis system comprising an electrolyzer for producing hydrogen and oxygen as product gases, with formation of a product gas stream in a phase mixture comprising water and a respective product gas with a proportion of a foreign gas. The invention further relates to a recombiner for cleaning a product gas stream from water electrolysis and to the use of a recombiner in an electrolysis system.

Hydrogen is nowadays produced, for example, by means of proton-exchange membrane (PEM) electrolysis or alkaline electrolysis. The electrolyzers produce hydrogen and oxygen from the supplied water with the aid of electrical energy.

An electrolyzer generally comprises a multiplicity of electrolysis cells arranged adjacently to one another. In the electrolysis cells, water is decomposed into hydrogen and oxygen by means of water electrolysis. In the case of a PEM electrolyzer, distilled water as reactant is typically supplied on the anode side and split into hydrogen and oxygen at a proton-exchange membrane (PEM). The water is oxidized to oxygen at the anode. The protons pass through the proton-exchange membrane. Hydrogen is produced on the cathode side. The water is generally conveyed into the anode space and/or cathode space from a bottom side.

This electrolysis process takes place in the so-called electrolysis stack, composed of multiple electrolysis cells. In the electrolysis stack which is under DC voltage, water is introduced as reactant, and passage through the electrolysis cells is followed by the exit of two fluid streams consisting of water and gas bubbles (oxygen O₂ or hydrogen H₂). The respective separation of aqueous phase and gas phase in the fluid streams takes place in so-called gas separators.

In practice, the oxygen gas stream contains small amounts of hydrogen as foreign gas and the hydrogen gas stream contains small amounts of oxygen as foreign gas. The quantity of the respective foreign gas in the respective product gas stream depends on the electrolysis cell design and also varies under the influence of current density, catalyst composition and aging and, in the case of a PEM electrolysis system, it also depends on the membrane material. Inherent to the system is the fact that the gas stream of one product gas contains the other product gas in very low amounts. In the further course of the process, even small traces of oxygen are generally removed from the hydrogen in downstream gas cleaning steps using in some cases very complex and cost-intensive cleaning steps, in particular if a particularly high quality of product gas is required, as is the case for instance when utilizing the hydrogen for, for example, fuel cells.

In an electrolysis system, gas cleaning of the product gas streams from the electrolyzer can be achieved, for example, by supplying both product gas streams in particular to a respective, catalytically activated recombiner in which a catalyst allows recombination of the hydrogen with the oxygen to form water (DeOxo unit), meaning that the respective product stream recombines into water. To this end, it is necessary to heat the gas stream beforehand to at least 80° C. so that the conversion rates of the recombiner are sufficiently high and the required gas purity is thus achieved. However, the processing system used for this purpose is quite costly and, because of its energy demand, reduces the system efficiency of the entire electrolysis system. A further possibility for dealing with the problem of foreign gas is to produce recombination-active surfaces within the electrolysis cell using specific treatment measures. However, from an economic point of view, these cell-internal recombination catalysts are highly complex and therefore disadvantageous.

Such an electrolysis system having a recombiner is disclosed, for example, in EP 3 581 683 A1. It describes an electrolysis device having a recombiner and a method for operating the electrolysis device. The electrolysis device comprises at least one electrolysis cell for splitting water into a first product comprising at least 98% by volume of hydrogen and into a second product comprising at least 98% by volume of oxygen. The electrolysis device further comprises at least one first passive recombiner comprising a catalyst for removing oxygen from the first product and/or at least one second passive recombiner comprising a catalyst for removing hydrogen from the second product, the recombiner being operable at temperatures of not more than 60° C.

Therefore, attention must already be paid to the purity and quality of the product gas streams which are initially formed in the electrolyzer and discharged from the electrolyzer, not only for operational safety, but also to keep the costs and complexity for the subsequent cleaning steps within reasonable limits.

The purity and quality of the two product gas streams of the gases originally produced in the electrolyzer is dependent on many parameters and can also change in the course of operation of an electrolysis system. It is a problem and of particular relevance to safety here if not only the concentration of oxygen in hydrogen increase, but also the concentration of hydrogen in oxygen increases. If a certain concentration limit is exceeded here, there is a potential hazard due to the accumulation of flammable gas mixtures. This occurs especially in the respective gas separator (container) immediately downstream of the electrolysis, and as a result, for example, the oxygen gas produced can no longer be transferred for further purposes. If the proportion of hydrogen in the oxygen product gas increases further, then a combustible or explosive mixture may even form. The gas separator (container) is then in a potentially dangerous operational state that must be absolutely avoided for safety reasons. This also applies, mutatis mutandis, to the hydrogen side.

Reliable and continuous monitoring of the gas quality of the product gases during operation of the electrolysis system is therefore essential. This particularly also applies to the oxygen side of the electrolyzer, i.e., the monitoring of the concentration of hydrogen as foreign gas component in the oxygen produced during electrolysis. Monitoring and appropriate operation are an important safeguard in order for critical operational states to be detected and in order for safety measures, up to and including temporary shutdown of the electrolysis system, to be taken. Appropriate precautions must also be taken on the hydrogen side, i.e., the monitoring of the concentration of oxygen as foreign gas component in the hydrogen produced just before a complex downstream gas cleaning system (DeOxo unit) is also an important safeguard on the hydrogen side.

### SUMMARY

In one embodiment, a method for operating an electrolysis system is provided. The electrolysis system including an electrolyzer for producing hydrogen and oxygen as product gases, with formation of a product gas stream in a phase mixture including water and a respective product gas with a proportion of a foreign gas, characterized in that rotation is imparted to at least one product gas stream so as to bring about phase separation of water and product gas in the phase mixture. The product gas is supplied to a catalytically active zone in which foreign gas is recombined with the product gas to form water, and after passage through the catalytically active zone, the product gas, from which the foreign gas has been removed, and a liquid phase are remixed to form a phase mixture.

In one embodiment, a recombiner for cleaning a product gas stream from water electrolysis is provided. The recombiner includes an inflow region with an inlet and having a catalytically active zone which is arranged downstream of the inflow region based on an axial flow direction (Z) and which is adjoined by an outflow region with an outlet, thus forming a flow channel. A swirl element is arranged in the inflow region and the catalytically active zone includes a catalyst designed for axially central flow of the product gas through the flow channel. The outflow region is designed for remixing of phases, thus making it possible to obtain a cleaned product gas stream.

### DETAILED DESCRIPTION

The invention is therefore based on the object of proposing a novel method for reducing the foreign gas in a product gas stream of a hydrogen electrolysis system. It is a further object of the invention to specify a device by means of which a particularly effective reduction of the foreign gas in a product gas stream of a hydrogen electrolysis system is achievable.

According to the invention, the object directed to a method is achieved by a method for operating an electrolysis system comprising an electrolyzer for producing hydrogen and oxygen as product gases, with formation of a product gas stream in a phase mixture comprising water and a respective product gas with a proportion of a foreign gas, wherein rotation is imparted to at least one product gas stream so as to bring about phase separation of water and product gas in the phase mixture, and wherein the product gas is supplied to a catalytically active zone in which foreign gas is recombined with the product gas to form water, wherein, after passage through the catalytically active zone, the product gas, from which the foreign gas has been removed, and the water in the liquid phase are remixed to form a phase mixture.

The electrolysis system may here be a high-pressure electrolysis system or a low-pressure electrolysis system that is configured for PEM electrolysis or for alkaline electrolysis.

“Product gas” refers here to the oxygen or hydrogen produced in the electrolysis system. “Product gas stream” is understood to mean the oxygen-side or hydrogen-side stream that, in addition to the respective product gas, may inter alia also comprise further components, for example water or the respective foreign product gas.

The invention is based just on the knowledge that previously proposed external, i.e., downstream, methods of gas cleaning and treatment of the product gases hydrogen and oxygen of an electrolysis system are very complex and cost-intensive. But also disadvantageous are cell-internal measures for reducing the causal internal transfer of gas within the electrolysis cell through the membrane, for instance for suppressing the transfer of hydrogen from the cathode space into the oxygen-side anode space. For example, it has been proposed that an additional ionomer component be applied at the membrane surface on the anode side, i.e., on the oxygen side, which is costly owing to the use of iridium material and also leads to losses in efficiency. Furthermore, cell-internal recombination catalysts have been proposed, but they can lead to faster degradation and thus faster aging of the electrolysis cell. Another measure mentioned, with disadvantages for the efficiency of the electrolysis system, is the use of thicker membranes as diffusion barrier to separate anode space from cathode space.

The invention is based on the basic idea of first performing a phase separation in the product gas stream itself, i.e., separating water and product gas, and then specifically and selectively catalytically removing the foreign gas in the product gas. It is thus advantageously not necessary to subject the entire phase mixture to gas cleaning in order to remove the foreign gas from the phase mixture. The phase separation is brought about by swirl flow or rotation, which is imparted to the product gas stream, specifically with advantage being taken of the separation effects in the material separation analogous to a centrifugal separator. The phase mixture is set into rotational movement by a specifically imparted rotation on the product gas stream—as a carrier of the phases or particles to be separated—on the basis of the distinct flow velocity thereof.

The liquid phase of the water and the gas phase of the product gas are thus spatially separated on the basis of particle mass or density differences. What is achieved is in situ swirl- or rotation-based spatial separation of the phases in the phase mixture combined with selective catalytic gas cleaning of the product gas. The gas cleaning is carried out by a recombination process by specifically supplying only the product gas to the catalytically active zone, where it recombines with the foreign gas to form water, thus cleaning the foreign gas from the product gas. A particular advantage with this gas cleaning concept during operation of an electrolysis system is that it is not only possible to efficiently remove hydrogen as foreign gas in the oxygen product gas, but also possible, vice versa, to efficiently remove oxygen as foreign gas in a hydrogen product gas. The method is usable in a flexible manner, cost-effective and simple to implement and it does not require any service life-reducing intervention in the electrolysis cell, such as the cell-internal measures described above. But the invention also has considerable advantages for operation of an electrolysis system compared to known external gas cleaning and gas treatment measures, especially since large concentrations of foreign gas in the respective product gas, for example owing to membrane breakthroughs, can be safely controlled as well.

Owing to the high cleaning efficiency of the method, it is possible for the foreign gas in the product gas in the gas phase to be practically completely removed or bound catalytically in the catalytically active zone to form water, i.e., for example hydrogen foreign gas in oxygen. Advantageously, the corresponding mixture need not be ignitable, i.e., for instance the concentration of hydrogen foreign gas in the oxygen can lie below the lower explosion limit (LEL) in a present operation. The huge advantage of this is that the efficient cleaning method according to the invention can already in principle avoid or even exclude ignitable mixtures and the risk of explosion during operation of the electrolysis system, which increases the operational safety of the system and service life. After passage through the catalytically active zone, water in the liquid phase is remixed with the catalytically cleaned product gas in the gaseous phase, thus yielding a phase mixture from which the foreign gas has been removed and which is composed of water with the respective product gas. Said phase mixture can be transported and processed in an electrolysis system for further purposes. Reseparation of phases is usually performed in a downstream gas separation device for the respective product gas, thus yielding oxygen or hydrogen as the respective product gas.

In one embodiment of the method, the product gas stream is guided in an axial flow direction, wherein, based on the axial flow direction, the phase separation is carried out in such a way that the water is conveyed into a radially outer region and the product gas is conveyed into a radially inner region.

In a cylindrical coordinate system, the axial flow direction corresponds to the z-axis and a radial coordinate of a point is defined by the ascertained radial distance perpendicular to the z-axis and a rotation angle. The rotational speed of a particle in the product gas stream is described by the rotation angle and the speed of rotation. The swirl- or rotation-induced spatial phase separation effects material separation of the liquid phase from the gaseous phase in the phase mixture, the mass or density of the materials resulting in the water being conveyed into the radially outer region and in the product gas being conveyed radially inward toward the z-axis centrally into the radially inner region, where the catalytically active zone is located. In the phase separation and gas cleaning, an effect similar to a cyclone separator is taken advantage of for the rotation movement dynamics to be achieved.

A tangential movement component is imparted to the product gas stream in the phase mixture or the mixture of product gas and water, said product gas stream flowing in an axial direction, and the product gas stream is thus brought onto a circular path. Owing to radial forces radially inward toward the z-axis and reduction of the radial component, the speed of rotation increases to such an extent that the heavier water particles are spun outward as a result of the centrifugal force and slowed down. The lighter product gas, by contrast, is conveyed into the inner region into the catalytically active zone and cleaned.

In one embodiment, heat of recombination produced in the catalytically active zone is transferred to the water flowing in the radially outer region, thus cooling the catalytically active zone.

What is thus achieved is a very advantageous intrinsic cooling of the catalytically active zone, around part or all of which the water in the radially outer region flows as a cooling medium. The resultant high level of process heat due to the catalytic recombination of hydrogen and oxygen to form water can thereby be transferred from the catalytically active zone and from the radially inner region into the radially outer region. Direct overheating of the catalytically active zone and possibly indirect overheating of further radial regions or delimiting elements, such as delimiting wall elements, beyond the radially outer region is thereby avoided without further measures. The heat absorption and the heat transfer due to the surrounding water in the radially outer region achieves a particularly effective thermal decoupling of the catalytically active zone and further radial regions. At the same time, the presently proposed reactive gas cleaning process is thereby intrinsically safe.

In one embodiment of the method, spreading of the reaction from the catalytically active zone is suppressed, thus extinguishing flashbacks.

Measures for spatial delimitation and containment of the recombination reaction in the catalytically active zone achieves increased safety with respect to flashback in the method. Examples of suitable measures for spatial delimitation of a reaction include the use of so-called quenching processes in chemical reaction control, which means the rapid stopping (extinguishing), slowing or suppression of a reaction that is proceeding. This can be achieved by the rapid addition of a further reaction partner, sometimes also referred to as a quencher, which removes one of the reactants from the reaction mixture, by cooling, which reduces the rate of the reaction that is proceeding to the extent that it is considered virtually stopped, or else by rapid and high dilution, which greatly reduces the likelihood of reaction between two reactants. The use of mechanical elements in the catalytically active zone for reaction delimitation is preferentially proposed here as a possibility, since it is simpler to implement.

Preferably, the catalytically active zone is heated to an activation temperature, thus initiating the recombination reaction.

It is advantageous to activate the recombination reaction by separate heating of the catalytically active zone, especially if the product gas stream from the electrolyzer does not already have a sufficiently high temperature level, and so there would be intrinsic activation of the reaction and the activation energy is already made available. Advantageously, heating to an activation temperature need be done only temporarily. Once the recombination reaction has been initiated, it will continue on its own, since the recombination reaction between hydrogen and oxygen to form water in the catalytically active zone is exothermic. Therefore, heat of reaction is produced continuously during normal operation.

In one embodiment of the method, an activation temperature which is above the temperature of the phase mixture of the product gas stream by 10 K up to 100 K, preferably by about 30 K to 80 K, is set. The necessary temperature level is ensured by an appropriate heat supply, for example from an external heat or energy source and local heat input into the catalytically active zone. Alternatively, the heat of activation can also be produced and provided directly and immediately in the catalytically active zone.

In one embodiment of the method, a pressure and/or a temperature and/or a volumetric flow rate at the inlet and/or outlet of the catalytically active zone is ascertained and the measurement value ascertained is processed in a control unit.

Here, local measurement variables characteristic of method control are determined or ascertained directly or indirectly and they are used to infer the current operational state in the catalytically active zone. Suitable measurement procedures comprising preferably the measurement and processing of pressure, temperature and volumetric flow rate advantageously make it possible to infer, for example, the foreign gas concentration in the product gas stream upstream and downstream of the catalytically active zone and thus the efficiency of the catalytic gas cleaning process.

According to the invention, the object directed to a device is achieved by a recombiner for cleaning a product gas stream from water electrolysis, comprising an inflow region with an inlet and comprising a catalytically active zone which is arranged downstream of the inflow region based on an axial flow direction and which is adjoined by an outflow region with an outlet, thus forming a flow channel, wherein a swirl element is arranged in the inflow region and the catalytically active zone comprises a catalyst designed for axially central flow of the product gas through the flow channel, and wherein the outflow region is designed for remixing of phases, thus making it possible to obtain a cleaned product gas stream.

The recombiner is particularly advantageously and efficiently usable and implementable in an electrolysis system, for instance for cleaning of a product gas stream from water electrolysis. In this respect, aspects and advantages of the above-described method arise correspondingly from the use of the recombiner and are realizable with the recombiner. However, the use is not limited to applications in water electrolysis. Rather, different recombiner applications are possible, where the task is that of separating phase or particle mixtures of different masses or densities and of cleaning them up catalytically at the same time.

The recombiner provides a, for example, tubular or cylindrical flow channel by means of which, firstly, phase separation of water and a product gas in the product gas stream is achievable by the swirl element and, secondly, catalytic gas cleaning of the product gas through chemical binding of a foreign gas is also achievable at the same time. Two functions are thus advantageously integrated in a single active flow element, the recombiner. There is also the structurally simple integrability into a line system, pipe system or other conveying system for mixed material streams of an industrial plant, in particular an electrolysis system.

For a phase separation that is to be achieved, the recombiner operates with certain functional similarity to a tangential cyclone separator and makes use of this basic principle, but advantageously adapts this principle to the specific requirements of separation of foreign gas from a phase mixture in combination with catalytic functionality. In the inflow region of the recombiner, which can have a cylindrical, conical or curved contour for example and acts as an inflow cylinder at the same time, there is arranged the swirl element. The swirl element is preferably in the form of a swirl blade for imparting a tangential velocity component and thus rotation to an inflowing product gas.

Via the inflow region of the recombiner, the phase mixture is thus suppliable tangentially by means of the swirl element and can be forced onto a circular path, in particular a cyclone-shaped path. The cyclone effect means that, when a product gas is admitted to the recombiner, the product gas is transported radially inward into the catalytically active zone and contacted with the catalyst. As a result, the recombiner is tailored for axially central flow through the flow channel, by means of which the catalytic reaction is restricted to the axially central region as reaction space that comprises the catalyst. The outflow region can be in the form of a separate spatial region of the flow channel in which, after passage through the catalytically active zone, the separated liquid phase and gaseous phase can be remixed, but with the foreign gas in the product gas having now been removed therefrom. However, it is also possible for the outflow region to be already in the form of a subregion of the catalytically active zone that is axially downstream in the flow direction and to be functionally integrated therein. This allows a more compact design for the recombiner, especially by realization of a smaller overall axial length. The recombiner is flexibly designable and adaptable with respect to the specific design of the inflow region, the swirl element, the catalytically active zone and the outflow region, depending on the separation task, the circumstances of use and the composition of the product gas stream. The outflow region forms a mixing zone or a phase mixing region specifically designed for remixing of phases. Thus, after passage through the catalytically active zone and cleaning of the product gas, remixing of product gas, from which foreign gas has now been removed, with the water is possible, and so what is obtainable with the recombiner is a cleaned product gas stream in a phase mixture composed of liquid phase (water) and gaseous phase (product gas). The outflow region is thus designed as a mixing section which brings about remixing of the fluids to form a phase mixture. Here, the product gas can be either hydrogen or oxygen from a water electrolysis.

In one embodiment, the recombiner comprises a fastening element by means of which the catalyst is held in a centered manner in the flow channel for axially central flow, wherein an annular space for flow around the catalyst is formed.

One possible and advantageous design of the fastening element is, for example, that of a bearing star having a number of radially oriented connecting pieces or spokes. The connecting pieces are connected to a central cylindrical holder, for example in the form of a hollow cylinder, which is used for accommodation, fastening and positioning of the catalyst. Geometrically, the annular space is then a space formed from two hollow cylinders. However, other geometries are also possible depending on the circumstances. It is found to be particularly advantageous for the annular space to be designed for flow around the catalyst, so that it is usable for the purposes of cooling. Thus, when for instance water or other cooling medium is admitted to the annular space, the catalyst can be cooled effectively and the heat of recombination from the catalyst material or the catalytically active zone can be dissipated to the cooling medium by heat transfer.

In one embodiment of the recombiner, there is arranged in the catalytically active zone a quenching device which delimits the catalyst on the inflow side and on the outflow side, thus suppressing flashback.

It is advantageous and particularly simple to design the quenching device as mechanical flashback protection, for example as a quenching sieve composed of a metallic material. A quenching sieve allows largely unimpeded flow through the flow channel and provides effective protection against flashback. The two-sided arrangement of the quenching sieve on the inflow side and on the outflow side means that complete containment or spatial delimitation of the recombination reaction in the catalytically active zone is achievable.

In one embodiment, the recombiner comprises a measurement device by means of which a pressure and/or a temperature and/or a volumetric flow rate at the inlet and/or outlet of the catalytically active zone is ascertainable.

A wide range of sensors, measurement sensors or probes are suitable for the measurement task and they are positioned directly on the catalyst, or as close as possible to the catalytically active zone upstream and/or downstream in the flow channel, in order to monitor the conditions as reliably as possible. These can be measurement points that are appropriately connectable to a control and evaluation unit.

In one embodiment, the pressure ascertained or the temperature ascertained or the volumetric flow rate (flow measurement) is compared with a respective reference value in a control unit and, in the event of a reference value being exceeded, operating parameters of the recombiner can be readjusted and operation control can be adapted, for instance by temperature control or flow control. Of particular advantage is the possibility of being able to determine the efficiency of recombination by means of the measurement device, i.e., the foreign gas concentration in the product gas in situ as a derived variable from the measurement values. Furthermore, the aging process in the catalyst can be monitored and followed. Overheating of the catalytically active zone can be detected, even though the risk of overheating of the catalyst is substantially avoided intrinsically, i.e., during operation, through the cooling concept.

In one embodiment, the recombiner comprises a resistance heating element arranged on the inflow side between the quenching device and the catalyst for heating of the catalyst.

By means of the resistance heating element, the necessary heat of activation is suppliable to the catalyst at least temporarily and as required when starting up the recombiner, and so the catalyst is thus heatable to the necessary operating temperature in order to catalyze the desired recombination reaction in the respective product gas stream. It is also conceivable to use a bake-out function for the resistance heating element, for instance for bake-out of the catalytically active zone for thermal cleaning thereof as required. In this way, damaging substances (catalyst poisons) which have accumulated during operation can be driven out or outgassed thermally. In this way, a regeneration function is additionally created in the recombiner comprising the heating element.

In a one embodiment, the catalyst comprises a support material based on an oxide material, in particular aluminium oxide Al₂O₃.

This choice of material for the support matrix of the catalyst is advantageous especially for the oxygen-side clean-up of a product gas stream from water electrolysis, i.e., the catalytic recombination of hydrogen as a foreign gas to form water in the oxygen product gas, i.e., on the anode side of a PEM electrolysis system.

In a further embodiment, the catalyst comprises a support material based on a non-oxide material, in particular stainless steel.

This choice of material is advantageous with respect to hydrogen-side clean-up of a product gas stream from water electrolysis, i.e., the catalytic recombination of oxygen as a foreign gas to form water in the hydrogen product gas, i.e., on the cathode side of a PEM electrolysis system.

In one embodiment, the recombiner is therefore used in an electrolysis system comprising an electrolyzer for producing hydrogen and oxygen as product gases.

Preference is given to especially the use of the recombiner within an electrolysis cell, a cell composite or a stack comprising a multiplicity of electrolysis cells.

Further preference is given to the use of the recombiner in the product gas line downstream, especially immediately downstream, of where the phase mixture exits from an electrolysis cell or a cell composite or a stack comprising a multiplicity of electrolysis cells.

Further preference is given to the use of the recombiner within a gas separation device of an electrolysis system and/or in a gas outlet line fluidically downstream of the gas separation device.

### BRIEF DESCRIPTION OF THE DRAWINGS

In the following, the invention will be elucidated by way of example on the basis of preferred embodiments with reference to the accompanying figures, and the features represented below can represent an aspect of the invention, either on their own or in different combinations with one another. In the figures:

FIG. 1 shows a schematic sectional representation of a recombiner according to the invention;

FIG. 2 shows a plan view of the inflow region of the recombiner according to FIG. 1;

FIG. 3 shows a sectional view of the recombiner according to FIG. 1 in the region of the fastening element; and

FIG. 4 shows by way of example an electrolysis system for water electrolysis having a recombiner according to the invention.

### DETAILED DESCRIPTION OF THE DRAWINGS

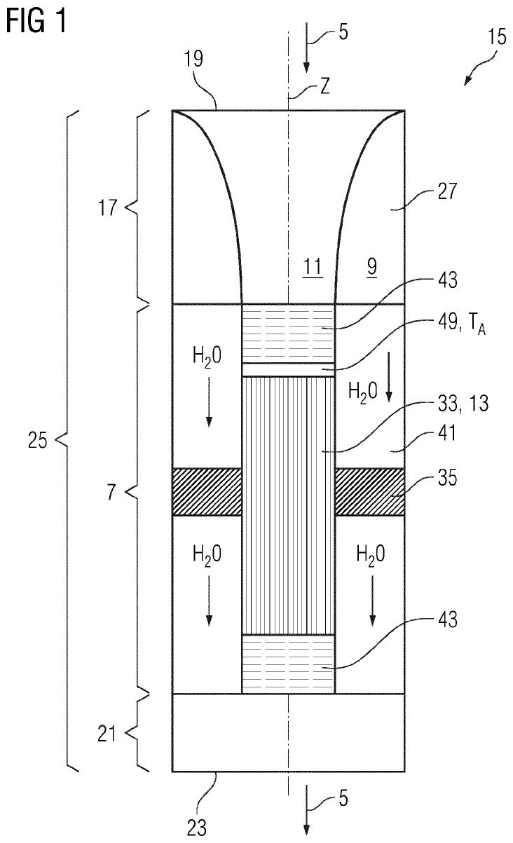

The recombiner 15 shown in FIG. 1 extends along a z-axis which simultaneously forms the axial flow direction when a product gas stream 5 is supplied and admitted to the recombiner 15. The recombiner 15 has along the z-axis an inflow region 17 with an inlet 19, and a catalytically active zone 7 which adjoins the inflow region 17 along the z-axis and which is adjoined by an outflow region 21 with an outlet 23. These elements form a flow channel 25 through which a product gas stream 5 is able to flow in the axial flow direction. The inflow region has a swirl element 27 which extends toward and opens into a radially inner region 11. What is realized as a result is a cylindrical flow channel 25 having an annular space 41 in which, at least in the catalytically active zone 7, the radially inner region 11 is surrounded and at the same time delimited by a radially outer region 9. In the catalytically active zone 7, a catalyst 33 is arranged centered along the z-axis by means of a fastening element 35, centered in the radially inner region 11, and is held in position. The catalyst 33 comprises a support material 13 based on an oxide material such as aluminium oxide Al₂O₃. Depending on the application and the circumstances of fitting the recombiner 15, the support material 13 of the catalyst 33 that is chosen can also be one based on a non-oxide, for example a metal such as stainless steel.

Both upstream and downstream of the catalyst 33, it is delimited by a quenching device 43 on its end face. The quenching device 43 is in the form of a metallic quenching sieve and the function thereof is to delimit a catalytic recombination reaction in the flow direction, thereby realizing particularly simple and effective flashback protection and high operational safety. A resistance heating element 49 is attached to the catalyst 33 and it is located at the end of the catalyst 33 facing the inflow region 17. This provides, as required, heating of the catalyst 33 to a necessary activation temperature T_{A}, for instance when starting up the recombiner 15 in order to initiate a catalytic reaction. A fluid is able to flow through the annular space 41 which is formed in the catalytically active zone 7 and which surrounds the catalyst 33, and so a fluid, for example water H₂O, is able to flow around the catalyst 33 in the flow direction, thereby making it possible to achieve cooling of the catalyst 33 during operation.

During operation of the recombiner 15, the swirl element 27 imparts a tangential movement component to a product gas stream 5 which is flowing into the inflow region 17 in the axial z direction and which is present in a liquid-gaseous phase mixture composed of a product gas with a proportion of foreign gas and water H₂O, and the product gas stream 5 is thus forced onto a circular path. Owing to radial forces radially inward toward the z-axis and reduction of the radial component, the speed of rotation increases to such an extent that the heavier water particles are spun outward into the radially outer region 9 as a result of the centrifugal force and slowed down. The lighter product gas with the proportion of foreign gas, by contrast, is conveyed into the radially inner region 11 of the catalytically active zone 7 and cleaned.

The basic idea here is that of first performing a phase separation in the product gas stream 5 itself, i.e., spatially separating water H₂O and product gas, and then specifically and selectively catalytically removing the foreign gas in the product gas. It is thus advantageously not necessary to subject the entire phase mixture in the product gas stream 5 to gas cleaning in order to specifically remove the foreign gas from the phase mixture. The phase separation is brought about by swirl flow or rotation, which is imparted to the product gas stream 5 by the swirl element 27, specifically with advantage being taken of the separation effects in the material separation analogous to a centrifugal separator. The phase mixture is set into rotational movement by a specifically imparted rotation on the product gas stream 5—as a carrier of the phases or particles to be separated—on the basis of the distinct flow velocity thereof.

The liquid phase of the water H₂O and the gas phase of the product gas are thus spatially separated on the basis of the different particle masses or the density differences. What is achieved is in situ swirl- or rotation-based spatial separation of the phases in the phase mixture combined with selective catalytic gas cleaning of the product gas. The gas cleaning is carried out by a recombination process by specifically supplying only the product gas to the catalytically active zone 7. On the catalyst 33, the product gas recombines with the foreign gas to form water, thus cleaning and virtually completely removing the foreign gas from the product gas. A particular advantage with this gas cleaning concept when using water electrolysis is that it is not only possible to efficiently remove hydrogen as foreign gas in the oxygen product gas, but also possible, vice versa, to efficiently remove oxygen as foreign gas in a hydrogen product gas. The recombiner 15 is therefore usable or configurable in a flexible manner, cost-effective and simple to implement. The heat of recombination produced in the catalytically active zone 7 is transferred to the water H₂O flowing in the radially outer region 9, and so the catalytically active zone 7 and specifically the catalyst 33 are cooled by the water H₂O flowing around said zone and catalyst.

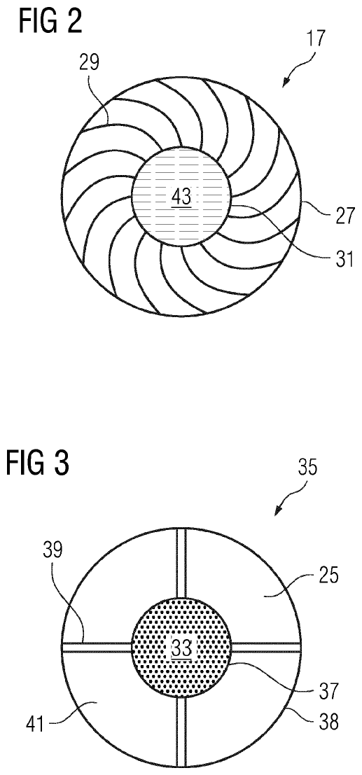

FIG. 2 schematically shows a plan view, looking in the direction of the z-axis, of the inflow region 17 of the recombiner 15 shown in FIG. 1. The swirl element 27 has a plurality of swirl blades 29 evenly distributed over a circular circumference. These bring about the imparting of a rotation with a tangential component to the fluid flowing into the inflow region 17 and the phase separation, as described above. Furthermore, there is a central opening 31 which shows the quenching device 43.

FIG. 3 shows, in a simplified representation, a sectional view of the recombiner 15 according to FIG. 1 in the region of the fastening element 35. Formed in the flow channel 25 is an annular space 41 which is delimited by an outer wall 38 and an inner wall 37. The fastening element 35 has four connecting pieces 39 which are arranged symmetrically over the circular circumference. By means of the fastening element 35, the catalyst 33 is brought into a central position and aligned and held along the z-axis. An annular space 41 is formed in the flow channel 25 as a result. During operation of the recombiner 15, water H₂O flows through the annular space 41 for the purposes of cooling. This water H₂O is obtained from the cyclone-based phase separation process, and it is eliminated and conveyed from the phase mixture into the radially outer region 9 in the inflow region 17. Very effective intrinsic cooling of catalyst 33 is achieved as a result.

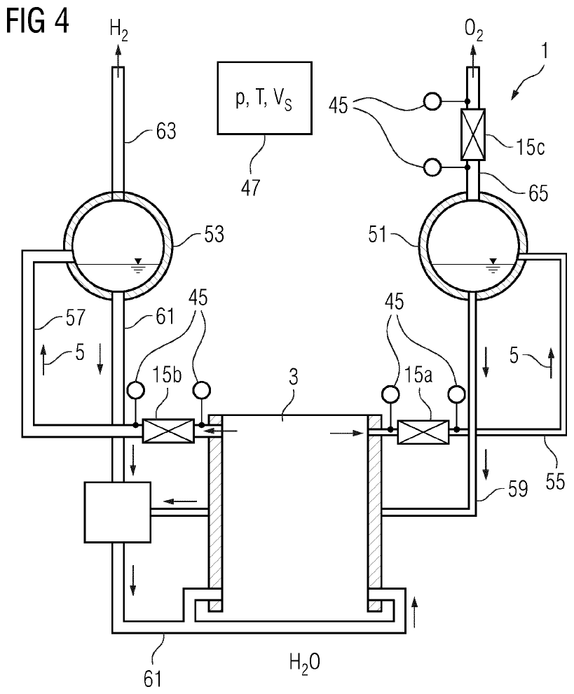

FIG. 4 shows one exemplary embodiment of an electrolysis system 1 for water electrolysis in which a recombiner 15 according to the invention is used particularly advantageously. In water electrolysis, water H₂O is electrochemically decomposed as reactant into an oxygen product gas O₂ and a hydrogen product gas H₂. For electrochemical decomposition, the electrolysis system 1 comprises an electrolyzer 3. The electrolysis system 1 also has a first gas separation device 51 on the oxygen side and a second gas separation device 53 on the hydrogen side. The electrolyzer 3 is connected to the first gas separation device 51 via a first product gas line 55 and to the second gas separation device 53 via a second product gas line 57. Accordingly, a phase mixture composed of water H₂O and oxygen O₂ is transported via the first product gas line 55. A phase mixture composed of water H₂O and hydrogen H₂ is conducted out of the electrolyzer 3 through the second product gas line 57. Separation of liquid and product gas subsequently takes place in the respective gas separation device 51, 53.

Furthermore, water H₂O from the first gas separation device 51 is recycled into the electrolyzer 3 via a water return line 59. The water H₂O from the second gas separation device 53 is conducted into a water supply line 61 of the electrolyzer 3.

In practice, the oxygen product gas stream 5 in the first product gas line 55 comprises small amounts of hydrogen H₂ and the hydrogen product gas stream 5 in the second product gas line 57 comprises small amounts of oxygen O₂. In order to remove these foreign gases from the respective product gas stream 5, it is necessary to clean up each of the product gases oxygen O₂ and hydrogen H₂, i.e., to subject the respective product gas stream 5 to corresponding gas cleaning.

For this purpose, various measures are taken in the electrolysis system 1 and for operation thereof that particularly advantageously make use here of the recombiner 15 of the invention. Thus, in the first product gas line 55 connected on the oxygen side and immediately downstream of where the product gas stream 5 exits from the electrolyzer 3, there is a recombiner 15a fitted into the product gas line 55. The oxygen-side product gas stream 5 is present in a phase mixture composed of water H₂O and the product gas oxygen O₂ with a proportion of hydrogen H₂ foreign gas. Further provided in the first product gas line 55 are measurement devices 45 comprising suitable sensors or measurement sensors, which are attached in the immediate vicinity of the recombiner 15a or in the flow channel 25 of the recombiner 15a to appropriately selected measurement points well-suited to the measurement task. As a result, characteristic variables such as pressure p, temperature T and volumetric flow rate Vₛ before and after flow through the recombiner 15a are determinable and are evaluable in a control unit 47. It is thus possible to determine derived variables such as the proportion of hydrogen foreign gas in the first product gas line 55 upstream and downstream of the recombiner 15a. Furthermore, the operational state can be ascertained and possible aging processes in the recombiner 15a, in particular the catalyst 33, can also be diagnosed. After the oxygen product gas from the electrolyzer 3 has flowed through the recombiner 15a, the product gas stream 55 has been cleaned. The proportion of hydrogen H₂ foreign gas in the oxygen O₂ product gas is practically negligible. Following passage through the recombiner 15 and because of the mixing of water H₂O and oxygen O₂, there is a cleaned phase mixture from which foreign gas has been practically completely removed.

Analogously, in the second product gas line 57 connected on the hydrogen side and immediately downstream of where the product gas stream 5 exits from the electrolyzer 3, there is a recombiner 15b fitted into the product gas line 57. The hydrogen-side product gas stream 5 is also present in a phase mixture composed of water H₂O and the product gas hydrogen H₂ with a proportion of oxygen O₂ foreign gas. Further provided in the second product gas line 57 are measurement devices 45 comprising suitable sensors or measurement sensors for monitoring the state of the product gas stream 5 and the function of the recombiner 15b. On the hydrogen side, the principle of efficient cleaning of the product gas by means of the recombiner 15b is in analogy to the above discussions on the gas cleaning on the oxygen side by the recombiner 15a. Both recombiners 15a, 15b are based on the basic principle of spatial phase separation of liquid water H₂O and gaseous product gas together with selective catalytic gas cleaning by recombination of the respective foreign gas to form harmless water H₂O. It is particularly advantageous to fluidically connect the recombiners 15a, 15b immediately downstream of where the product gas stream 5 exits from the electrolyzer 3 into the respective product gas line 55, 57. The volume or mass flow of the phase mixture is still compact and largely homogeneous in this case, which promotes effective flow through the recombiners 15a, 15b and effective gas cleaning. However, other ways of positioning a recombiner 15 and various combinations are also possible, such as downstream of where a partial product gas stream 5 exits from a cell composite or from a stack comprising a multiplicity of electrolysis cells. These variants of interconnection of a recombiner 15 to the cells themselves are not shown further in FIG. 4.

A further possibility of an advantageous interconnection downstream of the recombiner 15a is shown in FIG. 4 by way of example. Thus, downstream of the first gas separation device 51 on the oxygen side is a recombiner 15c, which is advantageously designed according to FIG. 1. The recombiner 15c is fitted into the gas outlet line 65 on the oxygen side and the product gas is able to flow through said recombiner. Here, the water H₂O has already been largely, but not completely, separated from the product gas by the phase separation in the gas separation device 51. Even after passage through the first gas separation device 51, a certain proportion of water or residual moisture in the product gas stream also continues to be present in the line 65. Thus, residual moisture can be removed by separation of the proportion of water in the recombiner 15c. Furthermore, any foreign gas components still present can be separated by catalytic recombination in the recombiner 15c in order to increase the efficiency of cleaning and the quality of the oxygen product gas.

Even if the recombiner 15a is temporarily taken out of operation, fails or provides an inadequate cleaning result, this combined interconnection of two recombiners 15a, 15c as a backup solution can be very useful and advantageous. However, the combined interconnection on the oxygen side of an electrolysis system 1, as shown here, is not mandatory, but is only shown exemplarily as an option. The recombiner 15c is also correspondingly equipped with measurement devices 45, and so characteristic measurement values can be transferred to the control unit 47 and evaluated.

It goes without saying that other embodiments can be used and structural or logical changes can be made without departing from the scope of protection of the present invention. Thus, features of the exemplary embodiments described herein can be combined with one another, unless specifically stated otherwise. The description of the exemplary embodiments should therefore not be interpreted in a restrictive manner, and the scope of protection of the present invention is defined by the appended claims.

The expression “and/or” used here, when used in a series of two or more elements, means that any of the listed elements can be used alone, or any combination of two or more of the listed elements can be used.

1. A method for operating an electrolysis system comprising an electrolyzer for producing hydrogen (H₂) and oxygen (O₂) as product gases, with formation of a product gas stream in a phase mixture comprising water (H₂O) and a respective product gas with a proportion of a foreign gas, characterized in that rotation is imparted to at least one product gas stream so as to bring about phase separation of water (H₂O) and product gas in the phase mixture, wherein the product gas is supplied to a catalytically active zone in which foreign gas is recombined with the product gas to form water (H₂O), and wherein, after passage through the catalytically active zone, the product gas, from which the foreign gas has been removed, and a liquid phase are remixed to form a phase mixture.

2. The method as claimed in claim 1, in which the product gas stream is guided in an axial flow direction (Z), wherein, based on the axial flow direction (Z), the phase separation is carried out in such a way that the water (H₂O) is conveyed into a radially outer region and the product gas is conveyed into a radially inner region.

3. The method as claimed in claim 2, wherein heat of recombination produced in the catalytically active zone is transferred to the water (H₂O) flowing in the radially outer region, thus cooling the catalytically active zone.

4. The method as claimed in claim 1, wherein spreading of a reaction from the catalytically active zone is suppressed, thus extinguishing flashbacks.

5. The method as claimed in claim 1, wherein the catalytically active zone is heated to an activation temperature (T_{A}), thus initiating a recombination reaction.

6. The method as claimed in claim 5, in which the activation temperature (T_{A}) is set above the temperature of the phase mixture of the product gas stream by 10 K to 100 K, preferably by about 30 K to 80 K.

7. The method as claimed in claim 1, wherein a pressure (p) and/or a temperature (T) and/or a volumetric flow rate (Vₛ) at an inlet and/or outlet of the catalytically active zone is ascertained and wherein a measurement value ascertained is processed in a control unit.

8. A recombiner for cleaning a product gas stream from water electrolysis, comprising an inflow region with an inlet and comprising a catalytically active zone which is arranged downstream of the inflow region based on an axial flow direction (Z) and which is adjoined by an outflow region with an outlet, thus forming a flow channel, wherein a swirl element is arranged in the inflow region and the catalytically active zone comprises a catalyst designed for axially central flow of the product gas through the flow channel, and wherein the outflow region is designed for remixing of phases, thus making it possible to obtain a cleaned product gas stream.

9. The recombiner as claimed in claim 8, comprising a fastening element by means of which the catalyst is held in a centered manner in the flow channel for axially central flow, wherein an annular space for flow around the catalyst is formed.

10. The recombiner as claimed in claim 8, in which there is arranged in the catalytically active zone a quenching device which delimits the catalyst on the inflow region and on the outflow region, thus suppressing flashback.

11. The recombiner as claimed in claim 8, comprising a measurement device by means of which a pressure (p) and/or a temperature (T) and/or a volumetric flow rate (Vₛ) at an inlet and/or outlet of the catalytically active zone is ascertainable.

12. The recombiner as claimed in claim 10, in which a resistance heating element arranged on the inflow region between the quenching device and the catalyst is provided for heating of the catalyst.

13. The recombiner as claimed in claim 8, in which the catalyst comprises a support material based on an oxide material, in particular aluminum oxide Al₂O₃.

14. The recombiner as claimed in claim 8, in which the catalyst comprises a support material based on a nonoxide material, in particular stainless steel.

15. The recombiner as claimed in claim 8, wherein the recombiner is used in an electrolysis system comprising an electrolyzer for producing hydrogen (H₂) and oxygen (O₂) as product gases.

16. The recombiner claimed in claim 15, within an electrolysis cell, a cell composite or a stack comprising a multiplicity of electrolysis cells.

17. The recombiner claimed in claim 15, in the product gas line downstream of where a phase mixture exits from an electrolysis cell or a cell composite or a stack comprising a multiplicity of electrolysis cells.

18. The recombiner claimed in claim 15, within a gas separation device of an electrolysis system and/or in a gas outlet line fluidically downstream of the gas separation device.
